(19) United States
(12) Patent Application Publication
(10) Pub. No.: US 2010/0146734 A1
(43) Pub. Date: Jun. 17, 2010

(54) Control hinge for stabilizing door

(76) Inventors: Dennis J. Munson, Des Peres, MO (US); Dale E. Aunspach, Creve Coeur, MO (US)

Correspondence Address: Paul M. Denk;Ste. 305, 763 South New Ballas Rd., St. Louis, MO, 63141, US

(21) Appl. No.: 12/653,346

(22) Filed: Dec. 11, 2009

Related U.S. Application Data
(60) Provisional application No. 61/201,924, filed on Dec. 16, 2008.

(51) Int. Cl. E05D 11/08; E05F 1/08; E05D 11/10

(52) U.S. Cl. 16/334; 16/337; 16/342; 16/340; 16/321; 16/319

(57) ABSTRACT

This invention relates to multiple configurations of devices to restrain a door or similar hinged, swinging appliance from autonomously swinging away from an initial fully or partially opened position to which it has been adjusted. No external, unattached parts are employed. The invention is applicable to any hinged, swinging object. It includes the use of either linear friction, such as through the use of compression nuts and springs applied to the hinged pin, so as to force the hinged knuckles into contact and frictional engagement. Another concept is the use of radial friction, through the application of either a slotted spring pin, or a spiral spring pin, that locates within the knuckles of the hinge components, to add friction to their pivotal movement when opening or closing of a door, or other structure.

### CROSS REFERENCE TO RELATED APPLICATION

This non provisional patent application claims priority to the provisional patent application having Ser. No. 61/201,924, which was filed Dec. 16, 2008.

### FIELD OF THE INVENTION

This invention relates to a unique hinge structure, wherein certain components are subject to frictional engagement that provides for stabilization of the door at the position it is moved to, between either an opened condition, or a closed condition, or partially thereby, so as to hold the door at a stationary position once fully or partially opened.

### BACKGROUND OF THE INVENTION

As has long been known in the art, doors or other hinged structures, or swinging objects, that are required or desired to remain in a fully or partially opened position, often tend to swing to either a fully opened position, or fully closed position, or at an undesirable intermediate position, either because of the gravitationally induced movement caused by the out-of-plumb alignment, vibration, or atmospheric pressure, or even temperature differentials. Or, anything as simple as a stiff breeze can push a door from its opened condition, into either closure or impact against another object, when blown open under such conditions. In the prior art, various types of external wedges or braces have been utilized to hold the swinging object, or door, in a desired position. Such wedges or braces are just inconvenient to use and are potentially dangerous as a tripping hazard, particularly for the elderly homeowner. Other devices usually attached to the door or other swinging object, and which incorporate means to lock the swinging object into position, have been applied. These types of devices require attachment to both the swinging object and to the fixed frame of some type, as well as a locking or fixing means that must be engaged to restrain the object and release it to free or reposition the swinging object, or the door. Examples of such applications include, but are not limited to, a hinged door or other swinging object such as residential or commercial wall doors, cabinet doors, doors or other swinging means as on vehicles such as trucks, aircraft, watercraft, and the like.

This invention provides a simple, new, useful and unique solution to the problems that are described above.

Other prior art patents that have shown structures having some relationship to the subject matter of this invention can be seen in the following patents.

The patent to Nunes, U.S. Pat. No. 4,078,276, is upon a Hinged Pin, wherein its cylindrical sleeve is formed of two sections that mate in a taper so that the sleeve can be disassembled and removed as required.

The patent to Steuer, U.S. Pat. No. 4,179,844, shows another form of hinge that is made up of various extruded components. It does incorporate the use of a wire-form spring.

The patent to Maggart, U.S. Pat. No. 4,438,597, shows an Adjustable Hinge Mount. This is simply a mount for supporting a door frame hinge.

The patent to Shank, U.S. Pat. No. 4,738,002, shows another Hinge Mounted Doorcheck. The purpose of this door check is to limit the amount of the door opening past a predetermined arcuate amount.

The patent to Hoffman, U.S. Pat. No. 4,761,853, shows a Self-Closing Hinge Structure. The purpose of this geared hinge, which includes resilient material within its structure, is to compress that material when the hinge members are moved, and to urge the door into a self-closing action through the hinge.

The patent to Keller, U.S. Pat. No. 4,949,427, shows a Hinge With Integral Detent And Stop. The hinge includes a spring, which acts in conjunction with an arcuate portion of the spring, to function as a stop which prevents further opening rotation of the hinge, during movement of the door.

The patent to Chavez, U.S. Pat. No. 5,033,161, discloses a Door Hinge with Knuckle Cylinder Having a Major Beveled Portion. The purpose of this beveling, upon the upper hinged cylinder, is to provide clearance for access of a tool when the hinge pin is to be removed.

The patent to Doring, U.S. Pat. No. 5,419,640, shows an Adjustable Support for Journals and Hinge Pins, Especially for Use with Doors and Gates. Its structure includes an eccentrically positioned receiving bore, for the hinge pin, and a cooperating set screw, which is used for adjustment in the hinge pins location within the hinge journals.

U.S. Pat. No. 5,642,910, to Betherum, is upon a Multi-Position Door Hinge Lock. The purpose of this hinge lock is to be used for holding the door either in an opened or closed position, relative to its doorway. Apparently, it includes a sleeve-like lock, with slots, that fit over the hinge, to hold the hinge parts together, or separated.

The patent to Green et al, U.S. Pat. No. 5,755,011, shows another Adjustable Hinge. This adjustable hinge features a vertical adjustment mechanism for selective movement of the first hinge member relative to the second hinge member.

Finally, the patent to Baer, U.S. Pat. No. 6,073,310, shows a Torque Resistant Hinge Bearing. This mechanism shows what appears to be an interengaged gear component associated with each hinge part that apparently resists rotation, when the hinge part is arranged in a particular location.

The current invention, to the contrary, for what is shown in the prior art, provides means for using frictional engagement, whether it be by surface friction, or spring pressure, to function as a door stop, at any particular location upon its opening, to hold the door at a fixed position, and resist further opening or closing, once adjusted.

### SUMMARY OF THE INVENTION

The purpose of this invention is to hold a hinged door in any desired position between fully open and fully closed in resistance to unwanted forces. This invention accomplishes this by creating bi-directional swing-resistant friction between the opposing knuckles of both section of a door or hinge. The bi-directional swing-resistant friction is created by applying and maintaining a tensile force in a specially designed hinged pin such as to squeeze the knuckles of opposing halves tightly together thus creating a bi-directional swing-resistant frictional torque. The pin tension is adjusted such that the magnitude of the swing resistant frictional torque will allow the door to be intentionally and easily moved to any position between fully open and fully closed, but will not allow the door to be moved by unwanted forces, such as wind or weight unbalance caused by out-out-plumb installation or building settling. Thus, the invention compensates automatically for knuckle-face wear that would relieve the interknuckular forces (and swing-resistant friction) and allow the door to swing more freely than desired.

Thus, the concept of this invention is to provide sufficient frictional force between select knuckles of the hinge plates, that holds the door into a set position, and fixes it at that location, but yet can be moved through manual force to other settings, as desired.

This invention relates to multiple configurations of hinge components and devices that restrain a door or similar hinged swinging appliance from an autonomously swinging away from an initially set fully or partially open position, in which it has been placed. The desired result is to accomplish that objective by means of easily installed and unique, adjunct hinge components. No modification is required to the door, the jams or the door frame, for installation of this operative hinge.

This is related primarily to various means for causing the door or other hinge, or swinging object to remain in the last partially open position to which it was placed. In its primary implementation, the invention consists of multiple ways of applying friction to the hinge or hinges of a swinging object, such as a door, in such a manner as to inhibit or prevent undesired swinging, but simultaneously to allow the object door to be positioned infinitely and easily to any desired point between fully opened and fully closed by application of a small, easily applied rotational force.

There are two fundamental means, linear friction and radial friction, by which this invention creates the optimal amount of hinge friction and resistance to swinging. A third method consists of a combination of the two fundamental methods and may be employed if a greater amount of stabilizing friction is required, as with heavier swinging objects, or if other destabilizing actions are present.

In one embodiment, spring pressure is applied to the pin of the hinge, thereby forcing the knuckles of the hinge into closer contact, for generation of friction, to thereby hold the door in position, once it is fully or partially opened.

A second structure, and method for achieving the results of this invention, includes the use of a frictional pin, which is spring bias of integral structure, which when slid through the hinge knuckles, will hold the hinge components at their adjusted position, and the door or other closure object to which the hinge is attached, so as to prevent further opening, or closing, of the structure once it has been adjusted.

Other variations upon these types of frictional generating pressures for holding the hinge components at select positions are considered within the linear friction and radial friction concepts that compose the subject matter of this invention.

It is, therefore, the principal object of this invention to provide a hinge structure that can maintain a door at a partially or fully opened condition, at the desire of the occupant.

Another object of this invention is to utilize linear generated friction upon the hinge components to adjust and hold a door at a select opened position.

Another object of this invention is to utilize radial friction, through the structure of the hinge pin, to hold a door or other structure at an adjusted position.

A further object of this invention is to provide a modified pin assembly for a door hinge that holds the door in a desired position, from fully closed to fully open, and anywhere in between, and thus dampens the swing of the door in either direction, and controls the door swing inertia.

A further object of this invention is to replace the standard pin of one hinge of a hinged swinging object with a uniquely designed pin assembly.

Yet another object of this invention is to provide a unique pin assembly for controlling autonomous door movement, whereby it may be set at installation, and require no further adjustment.

Still another object of this invention is to provide a custom pin for a standard hinge, and which functions to control movement of the door away from any position to which it has been placed.

Still another object of this invention is to provide a replacement pin for a hinge that is virtually unnoticeable.

Another object of this invention is to provide a unique pin assembly for a standard hinged door that eliminates the need for unsightly wall and door mounted stops.

Yet another object of this invention is to provide a unique pin assembly for a standard hinged door that avoids excessive swings, as from the force of wind, children hitting against the door, and therefore allows the door to be selected for a particular position, and to remain in that set location.

Still another object of this invention is to prevent a door from undertaking unwanted swings due to imbalance or other effects.

These and other objects may become more apparent to those skilled in the art upon review of this summary of the invention as provided herein, and upon undertaking a study of the description of its preferred embodiments, in view of the drawings.

### DESCRIPTION OF THE DRAWINGS

In referring to the drawings, FIG. 1 shows the control hinge and pin of the current invention;

FIG. 2 shows a threaded hinge pin with a hinge structure held by a compression therein to generate linear friction to hold a door at its adjusted open position;

FIG. 3 shows a similar hinge construction as shown in FIG. 1 with the addition of a spring or springs intermediate the compression nut and the hinge to further control the amount of generated friction within the hinge structure;

FIG. 4 shows a hinge incorporating radial friction through a slotted spring pin for holding the hinge components, and a door, at a desired adjusted position;

FIG. 5 shows an isometric view of the slotted spring pin;

FIG. 6 shows a modification to the slotted spring pin located within the structure of its associated hinge;

FIG. 7 shows an isometric view of the slotted spring pin with integral threads at either end of said pin;

FIG. 8 shows a modified hinge having a spiral spring located within the hinge in lieu of a pin;

FIG. 9 shows an isometric view of the spiral spring;

FIG. 10 shows the structure of a hinge having its pin located therein, with friction being generated by the spaced location of one or more friction rings;

FIG. 11 shows one of the frictions rings that locates within the hinge structure of FIG. 9;

FIG. 12 schematic of the swing-resistant torque of the said hinge pin of this invention;

FIG. 13 shows the chart of the spring characteristic usage of the standard hinge pin of this invention;

FIG. 14 shows spring force versus compression for hinge pin where its springs are series stacked;

FIG. 15 shows the chart for the combined forces versus spring compression for the hinge pin where its springs are parallel stacked;

FIG. 16 shows the chart of the combined force versus spring compression for the hinge pin where its springs are both series and parallel stacked;

FIG. 17 shows an upper taper of the hinge pin just below the application of the fastening nut thereto;

FIG. 18 shows a formed radius at the upper approximate end of the hinge pin, just below where the fastening nut applies thereto; and

FIG. 19 shows the application of a washer to the approximate upper end of the hinge pin, just below where the hinge nut applies thereto.

### DESCRIPTION OF THE PREFERRED EMBODIMENT

As can be seen from the figures previously described, there are various modifications to a hinge structure that can generate either linear friction or radial friction for holding the hinge components at an adjusted position, as when a door is partially opened, fully opened, or even to be held in closure.

The first method, referred to as the linear compression method, is implemented by applying a linear force by means of compression on a unique pin assembly, to cause an opposing force that will squeeze the hinge knuckles together, thus creating a rotation-resisting frictional force between the adjacent knuckle faces that is directly proportional to the applied compressive force and the coefficients of friction of the opposing knuckle material surfaces. A smaller component of motion-resisting force is also created by friction between the pin head and opposing knuckle surface at one end of the tensioned pin and a similar motion-resisting force at the opposite end of the pin.

FIG. 1 discloses the preferred embodiment for the hinge pin of this invention, generally noted at 1, the hinge pin includes a pin head 2 and has a bottom calibration nut 3 threadily engaged onto the lower end of pin 4 and axially located through the various knuckles 5 and 6 of the hinge plates 7 and 8 as can be noted. There are a series of disc springs, as at 9, there being several springs applied on to the pin, under its pinhead, and which biases against the upper knuckle 5 of the hinge plate 8, and in doing so, after the calibration nut has been tightened, the spring applies a significant force against the various knuckles through which the pin 4 inserts, hence these disc, springs apply a compression force against the two hinge plates, at the location of their knuckles, which causes a friction that maintains the hinge plates in any set position, to which the door has been adjusted and maintains the door at that adjusted position during the application and usage of this invention. The effects of the spring force, as from usage of one or more of these disc springs 9, will be subsequently reviewed analyzing the spring characteristics, and the amount of spring force that is applied versus the spring compression, and how this invention generates a constant hinge knuckle compressive force to maintain the hinge, and its supported door, at a set position, whether it be fully opened, closed, or any intermediate partially opened position, at the desire of the owner.

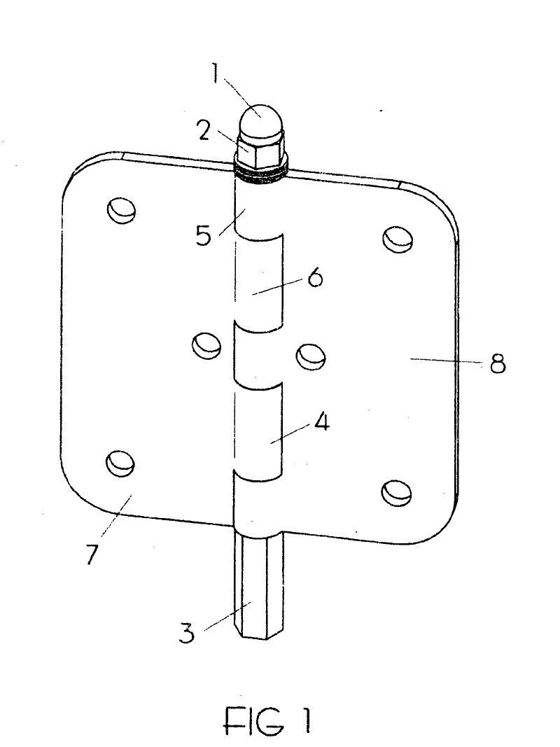

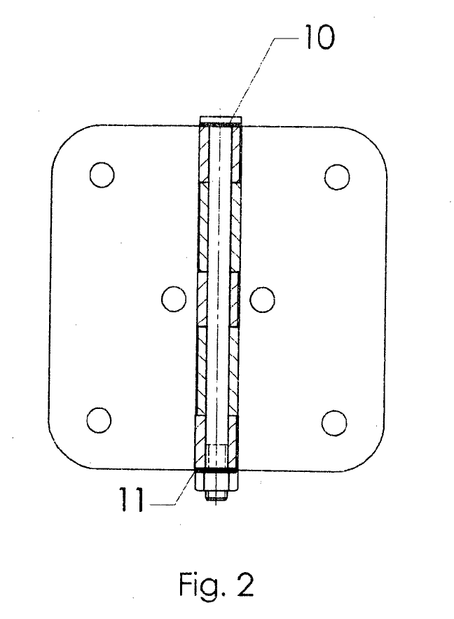

The modified embodiment of the linear compression method is illustrated by FIG. 2. A significant adjunct to the linear compression method consists of a spring 10 or series of springs 10 and 11 located between the compression nut and the adjacent hinge knuckle, or between the head on the opposite end of the pin and the adjacent hinge knuckle as in FIG. 1. The purpose of the spring or springs is to maintain a constant friction-causing interknuckular force to produce a constant swing-resisting friction by compensating for any wear that might occur on the adjoining knuckle surface.

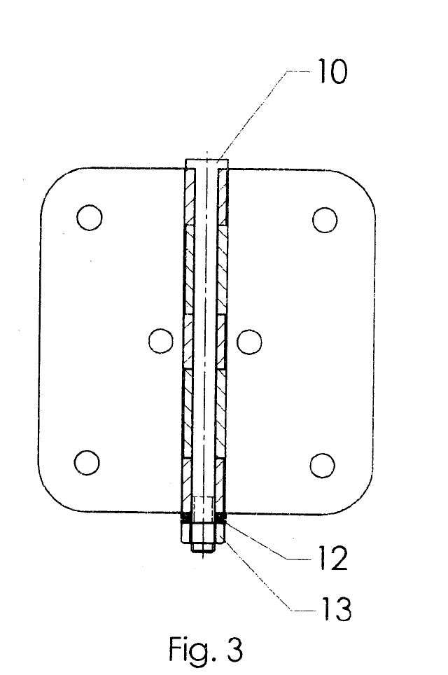

Another method is the same as the first method, except with a spring or springs 12 clamped between the end hinge knuckle face and the tension-producing nut 13 such that the spring, or springs, is compressed to maintain an essentially constant interknuckular force, and therefore, achieves essentially constant swing-resistant friction in the event of wear of the adjacent knuckle faces. This embodiment is shown by FIG. 3.

Another method, referred to as the radial compression method, is implemented by replacing a standard hinge pin with a hollow cylindrical spring pin 14 having a longitudinal slot 15 that extends the full length of the pin such that the circumference of the pin forms somewhat less than a full cylinder. The outside diameter of said hollow, slotted cylindrical spring pin is, in its free state, somewhat larger than the outside diameter of the hinge pin that is replaced by the slotted pin and is also an appropriate amount larger than the inside diameter of the hinge knuckles.

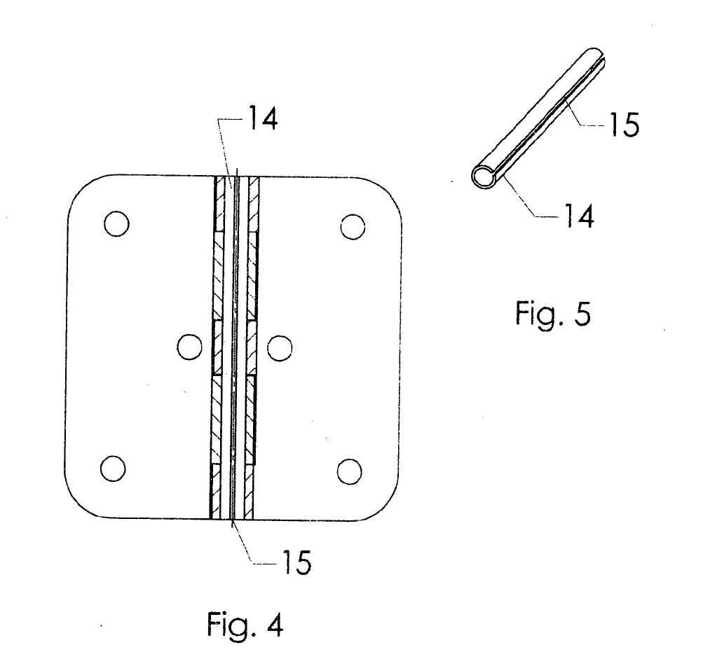

The hollow, cylindrical, longitudinally-slotted spring pin, when inserted into the inside diameters of the hinge knuckles, tends to expand outwardly, thus creating a radially outward compressive force that is counteracted by an equal and opposite radially inward force from the inside diameter of the hinge knuckles. The two opposing radial forces cooperate to create a motion-resistant frictional force that is directly proportional to the product of the radial force and the coefficients of friction of the pin and knuckle materials and the effective radius at which the friction force acts. The radial forces create sufficient friction to restrain and prevent unwanted swinging of the hinged object, but at the same time, allow the hinged object to be readily positioned at any point between fully open and fully closed. The embodiment of this concept is illustrated by FIG. 4 and FIG. 5.

Another embodiment, referred to as tensioned force, the hollow-slotted spring pin employs a hollow, slotted cylindrical pin 16 as used in the second embodiment except the pin is somewhat longer than the combined length of the hinge knuckles and each end of the pin is threaded as at 17 and 18, for a length sufficient to accommodate a matching threaded member of the threaded nuts 19 and 20. After the hollow, slotted cylindrical spring pin has been inserted into the hinge knuckles the proper distance, a standard threaded nut or similar fastener is threaded onto each extended end of the slotted spring pin and tightened to exert an adjustable friction force between the nut and opposing knuckle faces. Further tightening of the end nut will cause a modification of the outwardly radial force exerted by the hollow, slotted pin in accordance with Hook's Law that recognizes the linear relationship between stress and strain in the elastic regime. With this method, the radial contact force between the slotted pin and the inside surfaces of the hinge knuckles is initially greater than the optimum amount, thus creating swing-resistant friction somewhat greater than might be desired. This condition is compensated by progressive tightening of either of the two threaded fasteners at the ends of the slotted pin by causing the pin length to increase according to Hook's Law and the diameter to decrease according to Poisson's ratio. Tightening one or the other of one of the end nuts allows creation of an optimum ratio of radial-to-linear friction forces within and between the hinge knuckle which produces an optimum resistance to swinging of the hinged object.

This invention recognizes that, as the radial friction is decreased, the inter-knuckle force and friction is simultaneously increased. The net affect is to modulate the sensitivity of adjustment and compensate for inter-knuckle wear, thus maintaining a nearly-constant frictional resistance to unwanted swinging of a door or other hinged object.

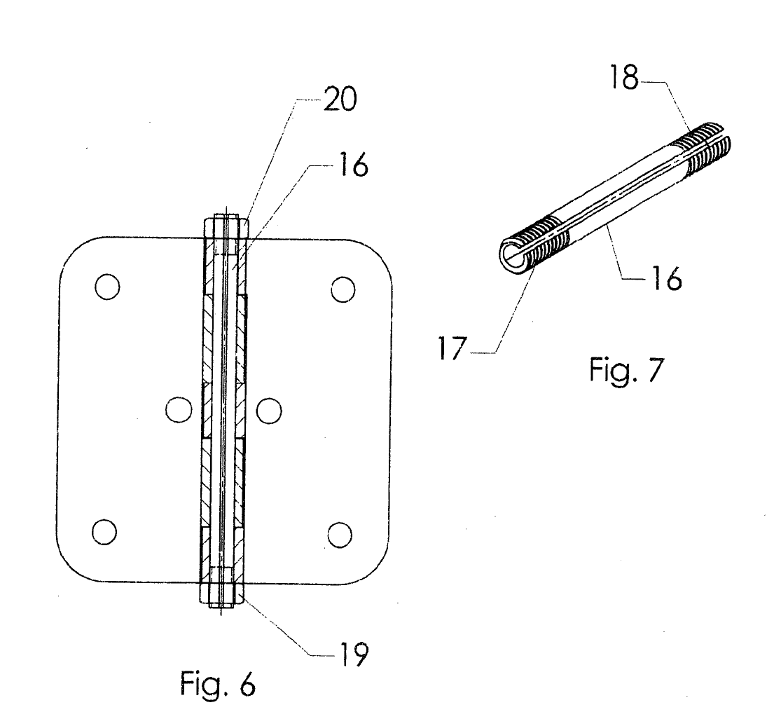

This embodiment allows optimum adjustment of the motion-resistant force while allowing easy positioning anywhere within the normal arc of the swinging object. This embodiment is shown by FIG. 6 and FIG. 7.

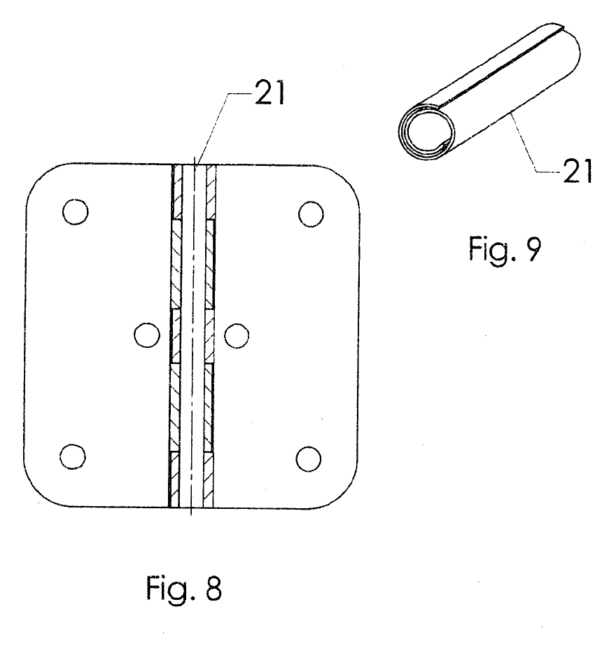

The further embodiment is created by any outwardly-expanding spiral spring 21 in cooperation with an optional pin positioned linearly thru the center of the spiral spring. The pin may have a head or nut on one end and a thread with nut and optional springs as previously described on the opposite end. The expanding spiral spring creates a constant outward force against the inside of the hinge knuckle thus creating a fixed spring-knuckle, with swing-resistant friction. Such friction, combined with the adjustable inter-knuckle friction created by pin tension, by the means previously described, is able to create sufficient swing-resistance to be especially applicable to heavier doors and other swinging objects. This embodiment is shown by FIG. 8 and FIG. 9.

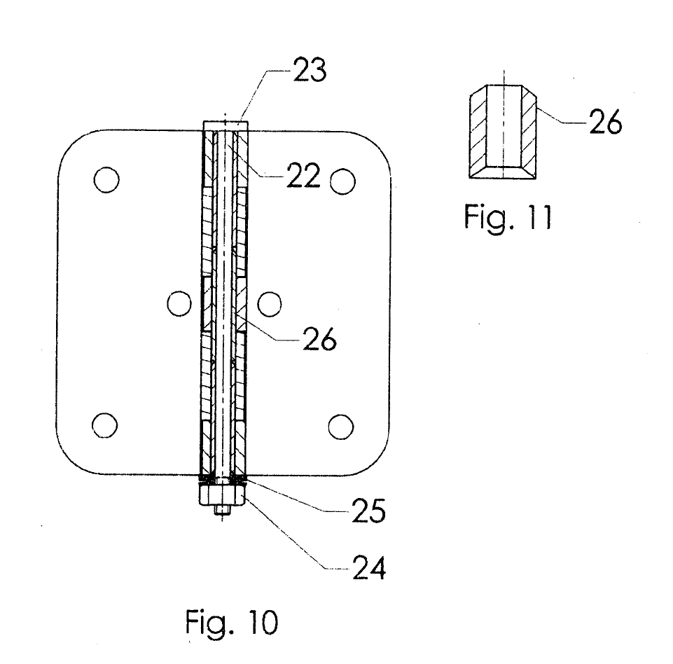

Another embodiment consists of a pin 22 of somewhat smaller diameter than the hinge knuckle bores. Said pin to have a head 23 or nut on one end and the opposite end threaded with a nut 24 and optional springs 25 as previously described. A series of rings 26 with inside diameter to slip easily over the pin and with an outside diameter to slip easily into the hinge knuckle bore. Such rings, of which there may be any number, may be of any effective cross-sectional shape and are stacked around the hinge pin such that the length of the stack is slightly greater than the length of the hinge. Alternatively, the ring stack may be shorter than the length of the hinge, as shown in FIG. 10, with a ferrule at the threaded end of the pin such that the ferrule extends beyond the edge of the hinge when the pin-ring-ferrule assembly is inserted thru the hinge knuckle bore. Optional springs, as previously described, may be installed between the ring or ferrule and the adjusting nut. Tightening of the adjusting nut compresses the rings causing them to expand both inwardly against the pin and outwardly against the hinge knuckle bores thus creating swing resistant friction to resist unwanted motion of the door or other swinging object.

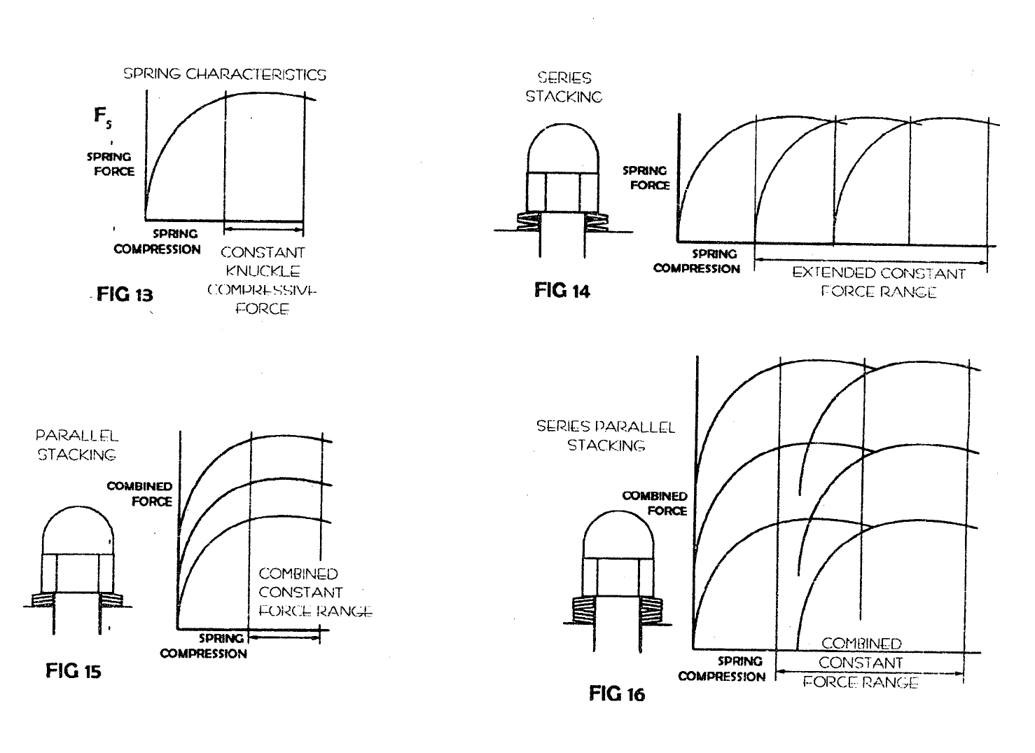

The hinge assembly as previously described in FIG. 2, consists of a standard door hinge, a special threaded hinge pin, a series of essentially constant-force springs and a universal calibration nut that will allow the same assembly to be used on hinges of various height. In operation, the calibration nut is tightening to create the desired amount of door-swing resistance. Tightening the calibrating nut creates swing-resistant interknuckular friction between the opposing hinge halves and compresses the constant force springs. The constant force springs, when compressed in a constant-force operating range, as shown in FIG. 13, will compensate for knuckle-face wear (which would otherwise relieve pin tension) by maintaining an essentially constant interknuckular force, and therefore constant swing-resistance.

The constant-force springs are designed to have a force versus compression characteristic similar to that shown in FIG. 13.

As described earlier, the bi-directional door-swing resistance depends upon the interknuckular friction that is created between the knuckle faces of the opposing hinge halves. The interknuckular friction versus torque relationship can be expressed as:

T=μ×r×Fs

### Where

T=Swing-resisting torque
μ=Coefficient of friction between knuckle faces
r=Effective radius at which the compression forces act on the knuckle faces
F=Spring force=Interknuckular compression force=pin tension

The coefficient of friction, μ, is a function of the knuckle material and surface finish, and independent of direction of rotation. The effective radius, r, depends on knuckle size and both r and μ are essentially constant for any hinge. Therefore, if the spring force remains constant, pin tension and interknuckular friction must remain constant resulting in constant bi-directional door-swing resistance.

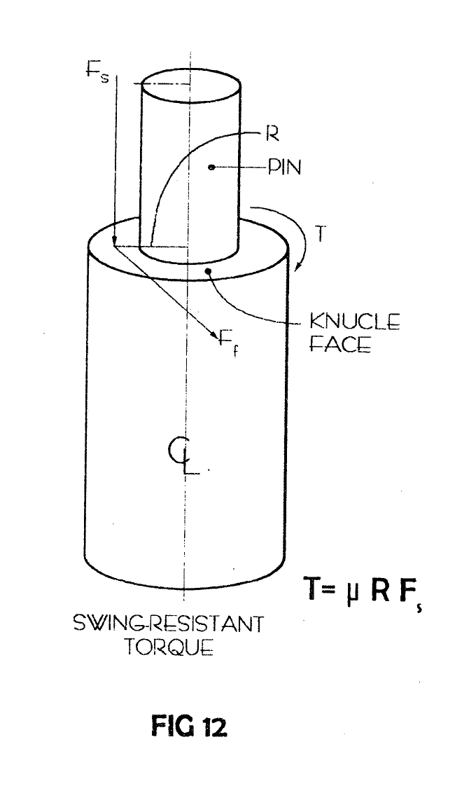

The relationship among the factors that effect the swing-resistant torque are shown, schematically, in FIG. 12.

Individual springs are designed to have force versus compression as shown by FIG. 13, however, the individual characteristics can be enhanced by stacking multiple disc springs in series, in parallel, or in combinations of both. These are shown in the charts provided in FIGS. 14, 15, and 16. Stacking elongates the effective constant-force range over greater range of compression which allows compensation for a greater amount of interknuckular wear as shown by FIG. 14. Parallel stacking results in greater stiffness which allows greater interknuckular force and greater door-swing resistance, generally as noted in the chart of FIG. 15. Series-parallel stacking allows creation of an optimum combination of stiffness and wear compensation as can be noted through the chart of FIG. 15. The springs may be stacked in any combination and/or number to produce an optimum pattern of swing-resistant friction in wear compensation.

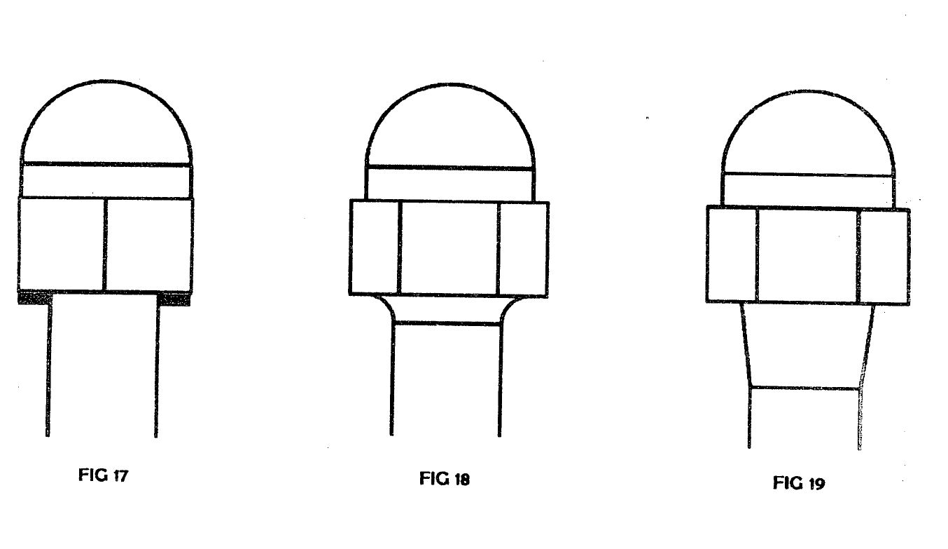

When the calibration nut 3 is tightened, there may be a tendency for the pin to rotate and inhibit tightening of the nut. That tendency may be offset by applying an offsetting torque to the head of the pin by a wrench or other means. More convenient methods of offsetting the calibration torques are included in the shape of the pin. The first method is to provide a low-angle taper or radius just under the pin head such that, as the calibration nut is tightened, the taper or radius is wedged into the inside diameter of the adjacent hinge knuckle resulting in a frictional torque to offset the torque applied by the calibration nut. See FIGS. 18 and 19. Another method of offsetting the calibration torques is to install a friction washer between the lower spring and the adjacent knuckle face. The washer material may be rubber, serrated metal, or other material having a high coefficient of friction. See FIG. 17.

Variations or modifications to the subject matter of this invention may occur to those skilled in the art upon review of the development as disclosed herein. Such variations, if within the spirit of this development, are intended to be encompassed within the scope of the claims to this invention.

We claim:

1. A control hinge for stabilizing a door or other structure, and for use in inhibiting or preventing the unwanted rotation of a door or other swinging object once it has been opened or closed to an adjusted position, said hinge including a pair of face plates, each face plate having at least one integral knuckle, each knuckle having a clearance cavity provided centrally therethrough, a hinge pin locating through the cavities of the aligned hinged knuckles, and a frictional force applied to a least one said knuckle to sustain the door in its adjusted position during usage.

2. The control hinge for stabilizing door of claim 1, wherein the hinge pin applies a radial frictional force to at least one of the hinge knuckles.

3. The control hinge for stabilizing door of claim 1 wherein the hinge pin applies a linear frictional force against at least one opposing pair of the hinged knuckles during application.

4. The control hinge for stabilizing door of claim 1 wherein the hinge pin is threaded at its lower end and a compression nut is applied thereto for exerting a linear frictional force against at least one opposing pair of the hinge knuckles during usage.

5. The control hinge for stabilizing door of claim 4 and including at least one spring, applied onto the upper end of the hinge pin, and tightened by said compression nut against the adjacent knuckle to exert a linear frictional force between the knuckles and to sustain the door at its adjusted position.

6. The control hinge for stabilizing door of claim 4 and including at least one spring, applied onto the lower end of the hinge pin, and tightened by said compression nut against the adjacent knuckle to exert a linear frictional force between the knuckles and to sustain the door at its adjusted position.

7. The control hinge for stabilizing door of claim 2, wherein said hinge pin is a length of spring, having a slot therein, and provided for exertion of radial frictional force against the hinge knuckles to hold any door at its adjusted position during usage.

8. The control hinge for stabilizing door of claim 1, wherein said hinge pin is a spiral spring, said spiral spring exerting pressure against at least one of the hinge knuckles to sustain the operative door at its adjusted position during usage.

9. The control hinge for stabilizing door of claim 1, wherein the pin extends upwardly and downwardly from the hinge knuckles, said upper and lower ends of the hinge pin being threaded, and a compression nut applied to each threaded ends of the spring pin.

10. A control hinge for stabilizing a door or other structure, and for use in inhibiting or preventing the unwanted rotation of a door or other swinging object once it has been opened or closed to an adjusted position, said hinge including a pair of face plates, each face plate having at least one integral knuckle, each knuckle having a clearance cavity provided centrally therethrough, a hinge pin locating through the cavities of the aligned hinge knuckles, and a linear frictional force applied to at least one of said knuckles to sustain the door in its adjusted position during usage.

11. A control hinge for stabilizing a door or other structure, and for use in inhibiting or preventing the unwanted rotation of a door or other swinging object once it has been opened or closed to an adjusted position, said hinge including a pair of face plates, each face plate having at least one integral knuckle, each knuckle having a clearance cavity provided centrally therethrough, a hinge pin locating through the cavities of the aligned hinge knuckles, and a radial frictional forced applied to at least one said knuckles to sustain the door in its adjusted position during usage.

12. The control hinge of claim 5 or 6, and including a plurality of disc springs applied onto the hinge pin and tightened by a compression nut to exert a linear frictional force between the knuckles and to sustain the door at its adjusted position.

13. The control hinge of claim 12 and wherein said springs are applied in series upon the hinge pin.

14. The control hinge of claim 12 in wherein said disc springs are applied in parallel upon the hinge pin.

15. The control hinge of claim 12 wherein the disc springs are applied both in series and parallel in their stacking upon the hinge pin in this application.

16. The control hinge for stabilizing door of claim 3 and wherein said hinge pin has a taper formed approximate its upper end.

17. The control hinge for stabilizing door of claim 3 wherein said hinge pins has a radius formed proximate its upper end.

18. The control hinge for stabilizing door of claim 3 and including a washer applied to the upper end of the hinge pin and biased against the upper hinge knuckle.

19. A hinge pin for use with a control hinge for stabilizing a door or other structure, said hinge pin having a pin length exceeding the height of the hinge, a pin head applied to the upper end of the hinge pin, said hinge pin having a threaded lower end, a calibration nut capable of threadedly engaging onto the lower end of the hinge pin, and tightened to provide an interknuckular force between the knuckles of the hinge plates formed of the control hinge.

20. The hinge pin of claim 19, and including at least one disc spring applied to the hinge pin as its calibration nut is tightened upon said hinge pin.

21. The hinge pin of claim 20 and including a series of disc springs applied to the pin before tightening of the calibration nut, and said series of disc springs being applied in one of series or parallel stacking when applied to the pin for tightening.

22. A hinge pin for use with a control hinge for stabilizing a door or other structure, said hinge pin comprising a length of spring, having a slot therein, and provided for exertion of a radial frictional force against the hinge knuckle to hold any door at its adjusted position during usage.

23. A hinge pin for use with a control hinge for stabilizing a door, wherein said hinge pin is a spiral spring, said spiral spring exerting pressure against one of the hinge knuckles to sustain the operative door at its adjusted position during usage.

24. A hinge pin for use with a control hinge for stabilizing a door or other structure, said hinge pin having a pin length exceeding the height of the hinge, a pinhead applied to the upper end of the hinge pin, said hinge pin having a threaded lower end, a calibrating nut capable of threadedly engaging onto the lower end of the hinge pin, and tightened to provide an interknuckular frictional torque force between the knuckles of the hinge plate formed of the control hinge, the torque frictional force being established at that force necessary to hold the door at its adjusted position during usage, and said torque frictional force being determined through the formulation:
T=μ×r×Fs
Where
T=Swing-resisting torque
J=Coefficient of friction between knuckle faces
r=Effective radius at which the compression forces act on the knuckle faces
F=Spring force=Interknuckular compression force=pin tension,
whereby the spring force remains constant, pin tension and interknuckular friction remains constant, resulting in constant bi-directional door-swing-resistance between the knuckles of the hinge plates.
